(19) United States
(12) Patent Application Publication
(10) Pub. No.: US 2011/0232105 A1
(43) Pub. Date: Sep. 29, 2011

(54) Hair Cutting Machine

(76) Inventors: Ute EBENHOCH, Aull (DE); Siegfried EBENHOCH, Aull (DE)

(21) Appl. No.: 13/034,185

(22) Filed: Feb. 24, 2011

Related U.S. Application Data
(63) Continuation of application No. PCT/US2009/054819, filed on Aug. 25, 2009.

(51) Int. Cl. B26B 19/38

(52) U.S. Cl. 30/196

(57) ABSTRACT

In order to provide the option of dividing up the hair with one-handed use of the hair cutting machine for a hair cutting machine having a gripping piece, two clipper blades, as well as a drive to generate a relative movement of the clipper blades, it is proposed that a dividing tip be provided on the hair cutting machine and that said dividing tip be connected to the hair cutting machine via a connection.

### CROSS REFERENCE TO RELATED APPLICATION

This application is a continuation application of prior copending International Application No. PCT/US2009/054819, filed Aug. 25, 2009, designating the U.S.

### FIELD OF THE INVENTION

The subject matter of the invention relates to the salon industry and an electric hair cutting machine therein.

Electric hair cutting machines are sufficiently well-known. They are used to cut scalp hair and are an alternative to cutting hair using scissors.

### BACKGROUND OF THE INVENTION

DE 10338401 A1 discloses an electric hair cutting machine of conventional design. This electric hair cutting machine is equipped with a gripping piece, which has a longitudinal axis, as well as a drive, a fixed clipper blade, and a clipper blade that is aligned parallel to and adjoins the fixed clipper blade and can be moved back and forth on a cutting plane, such that hair can be cut along a cutting line.

The use of a hair cutting machine alone to execute an exact haircut is not sufficient for many applications. A hairdresser must also use a comb to separate individual hairs or hair strands before the hairdresser uses the hair cutting machine in the upper region of the head. This is disadvantageous in that the hairdresser must hold a hairdressing device in each hand. Thus, the hairdresser must first set down one of the devices to free up one hand in order, for example, to grasp and apply a cosmetic hair product or to exercise some other type of hand grip, for example, to hold a strand of hair.

The object of the invention is to provide an improved hair cutting machine such that this disadvantage is reduced.

### SUMMARY OF THE INVENTION

The object is achieved in that a dividing tip is provided on hair cutting machine and that the dividing tip is connected to the hair cutting machine using a connection.

The proposed innovation has the advantage that a hairdresser can use the dividing tip as a fixture to divide up a section of hair without having to set down the hair cutting machine. The hairdresser can then use the other hand for other purposes. Because the dividing tip is connected to the cutting machine, this tip can be used in a manner similar to that of a comb by moving the hair cutting machine.

Advantageous embodiments of the proposed hair cutting machine are described in the dependent Claims.

If the connection between the hair cutting machine and the dividing tip is rigid, the dividing tip can be securely used in a specified direction. On the other hand, if the connection has a joint such that the dividing tip can be swiveled with respect to the hair cutting machine, the dividing tip can either be swiveled into a working position or placed back into a position on the surface of the hair cutting machine when the dividing tip is not intended for use. With this embodiment, it is then more advantageous if a stop is provided for the dividing tip in order to fix said tip into a certain practical swivel position.

In one embodiment the dividing tip does not interfere with the handling of the hair cutting machine, provided the dividing tip is not intended for use when the dividing tip is integrated into an exterior surface of the hair cutting machine in a position in which the dividing tip is not swiveled outward. In this process, well-known technology, for example, can be used to snap the dividing tip into a recessed position by pressing on it once. Pressing a second time releases the dividing tip and a spring action causes it to swivel outward.

The dividing tip can be subsequently attached to a hair cutting machine if the dividing tip is provided on an attachment piece and the attachment piece is constructed such that it can be attached to the hair cutting machine. To that end, it is particularly desirable if the attachment piece is constructed as a ring, an ellipsoid, or a loop in a suitable manner and can be slid over the gripping piece or the clipper blades. It can be held in a suitable position by friction or snapping.

In another embodiment the dividing tip can be best utilized when it has an end that points in a direction proceeding parallel to a center axis of the gripping piece or that forms a sharp angle with said center axis. This results in advantageous handling of the dividing tip.

If in a further embodiment a dividing tip is provided on the opposing sides of the hair cutting machine and these dividing tips are offset with respect to one another in the direction of a cutting line, one of the dividing tips can be used by a left-handed person and the other dividing tip can be used by a right-handed person. Or, both of the dividing tips can be utilized by one hairdresser, depending on the location of the hair strand to be divided. A similar but alternative advantage is achieved if an attachment piece having a dividing tip can also be attached in a position that is rotated by 180° with respect to the hair cutting machine, around the center axis of the attachment piece, in order to achieve an embodiment for a right-handed person or for a left-handed person.

### BRIEF DESCRIPTION OF THE DRAWINGS

The proposed hair cutting machine is described in more detail in the following using figures showing exemplary embodiments. The following is shown:

FIG. 1 shows a side view of an electric hair cutting machine with two dividing tips on one gripping piece;

FIG. 2 shows a perspective view of a hair cutting machine with one dividing tip in a folded-in position;

FIG. 3 shows a perspective view of the hair cutting machine according to FIG. 2, but with a partially extended dividing tip;

FIG. 4 shows a perspective view of the hair cutting machine according to FIG. 2, but with a completely extended dividing tip;

FIG. 5 shows a side view of a hair cutting machine with an attachment piece on which a dividing tip is constructed;

FIG. 6 shows a side view of a hair cutting machine with an attachment piece with a different construction; and

FIG. 7 shows a side view of a hair cutting machine with a dividing tip that can be retracted.

### DETAILED DESCRIPTION OF THE INVENTION

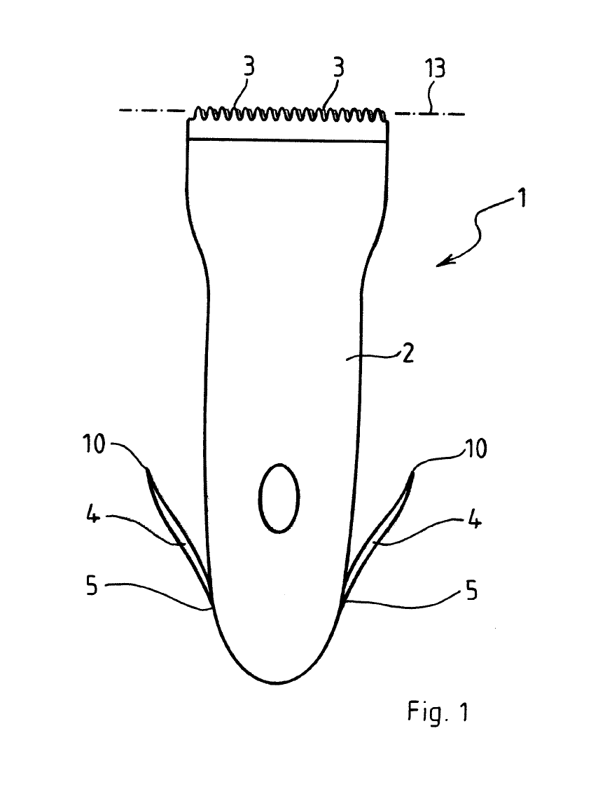

With a hair cutting machine 1 having a gripping piece 2, two clipper blades 3, as well as a drive to generate a relative movement of the clipper blades 3, two dividing tips 4 are provided, each of which is connected to the gripping piece 2 of the hair cutting machine 1 using a rigid connection 5 (FIG. 1). A dividing tip 4 is attached on opposing sides of the hair cutting machine 1 and the dividing tips 4 are offset with respect to one another in the direction of a cutting line 13 in order to divide up the hair to be cut. Depending on whether a separation is to be carried out on the left or right area of hair, the end 10 of the right or the left dividing tip 4 is used in order to accomplish this.

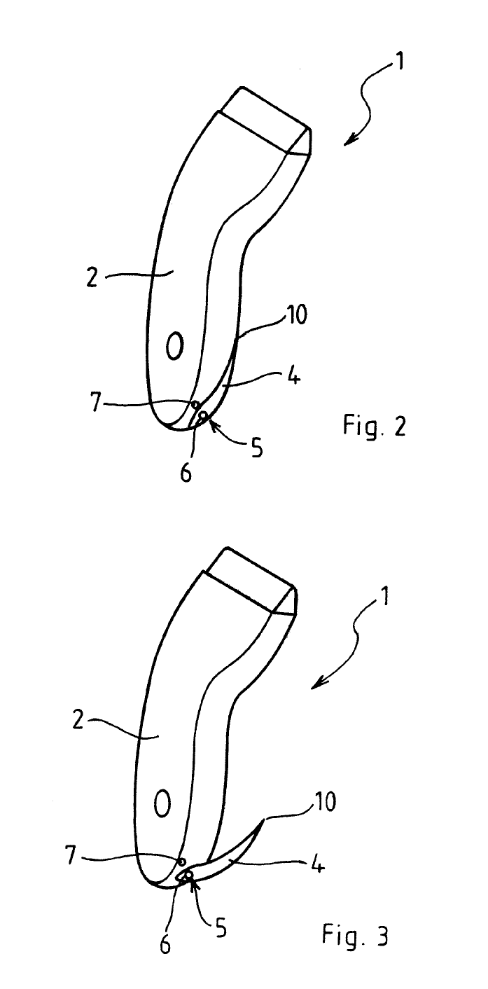

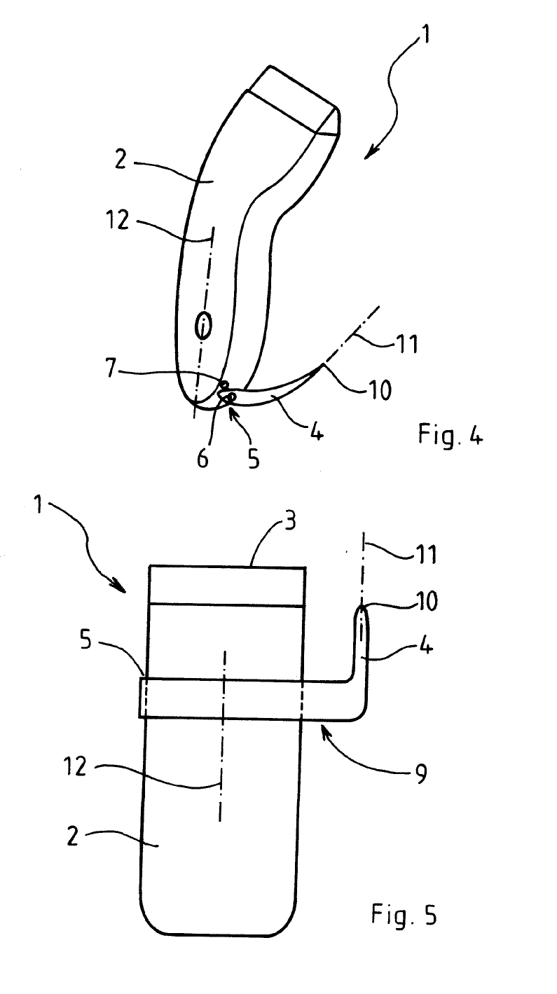

With the exemplary embodiment according to FIGS. 2 through 4, there is a dividing tip 4 on the rear end of a hair cutting machine 1, in a manner that is non-interfering, in a retracted condition on the external surface of a gripping piece 2 (FIG. 2). The connection 5 between the dividing tip 4 and the gripping piece 2 has a joint 6 so that the dividing tip 4 can be either partially (FIG. 3) or completely (FIG. 4) swiveled, with respect to the hair cutting machine 1. In the completely extended condition, a stop 7 serves to fix the dividing tip 4 in its maximum swivel position. The dividing tip 4 has an end 10, which points in a direction 11 that forms a sharp angle with a center axis 12 of the gripping piece 2.

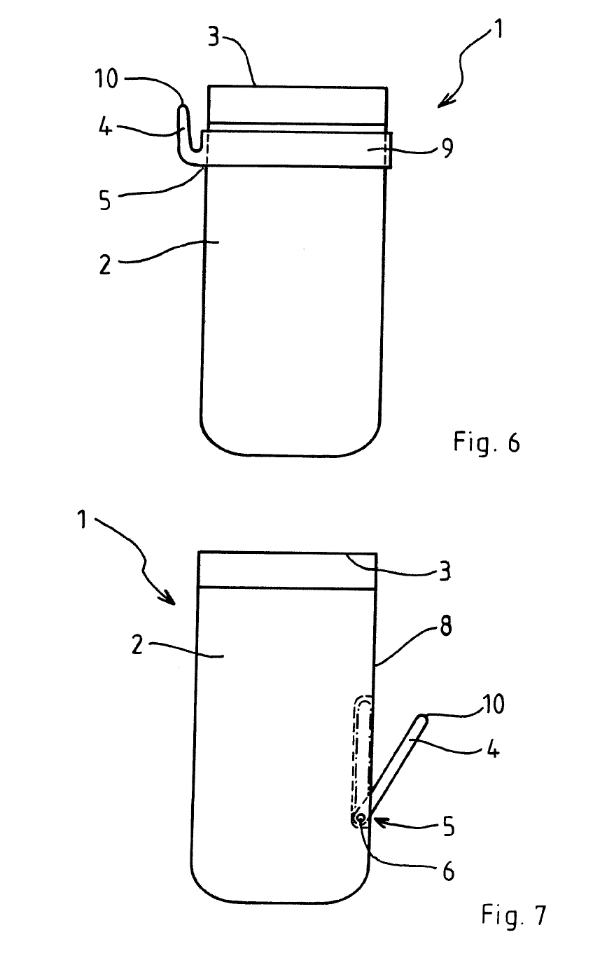

With the exemplary embodiments according to FIGS. 5 and 6, the dividing tip 4 is provided on an attachment piece 9. The attachment piece 9 is constructed so that it can be attached to the hair cutting machine 1 either from the clipper blade or from the end of the gripping piece 2. The attachment piece 9 is designed to approximate a rectangle and is pushed onto the gripping piece as a loop until it is fixed into position due to increased local friction. Common to both exemplary embodiments is that attachment piece 9 can also be attached to hair cutting machine 1 in a position that is rotated by 180° with respect to hair cutting machine 1, around the center of attachment piece 9, in order to have a design for a right-handed person or for a left-handed person.

In the exemplary embodiment according to FIG. 7, the dividing tip 4 is integrated into an external surface 8 of the hair cutting machine 1 in a position that is not extended (shown by the dotted line) and can be unfolded into an extended target position.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A hair cutting machine having a gripping piece, two clipper blades, as well as a drive to generate a relative movement of the clipper blades, wherein a dividing tip is provided on the hair cutting machine and said dividing tip is connected to the hair cutting machine via a connection.

2. The hair cutting machine according to claim 1, wherein the connection is rigid.

3. The hair cutting machine according to claim 1, wherein the connection has a joint such that the dividing tip can be swiveled with respect to the hair cutting machine.

4. The hair cutting machine according to claim 3, wherein a stop is provided for the dividing tip in order to fix said dividing tip into a certain swivel position.

5. The hair cutting machine according to claim 3, wherein the dividing tip is integrated into an external surface of the hair cutting machine in a position that is not extended.

6. The hair cutting machine according to claim 1, wherein the dividing tip is provided on an attachment piece and the attachment piece is constructed such that it can be attached to the hair cutting machine.

7. The hair cutting machine according to claim 6, wherein the attachment piece is constructed as a ring, an ellipsoid, or a loop and can be slid over the gripping piece or the clipper blades.

8. The hair cutting machine according to claim 1, wherein the dividing tip has an end, which points in a direction, which is parallel to a center axis of the gripping piece or which forms a sharp angle with said center axis.

9. The hair cutting machine according to claim 1, wherein a dividing tip is provided on opposing sides of the hair cutting machine and the dividing tips are offset with respect to one another in the direction of a cutting line.

10. The hair cutting machine according to claim 6, wherein the attachment piece can also be attached to the hair cutting machine in a position that is rotated by 180° with respect to the hair cutting machine, around the center of the attachment piece, in order to have a design for a right-handed person or for a left-handed person.
